(19) United States
(12) Patent Application Publication
(10) Pub. No.: US 2026/0276261 A1
(43) Pub. Date: Sep. 17, 2026

(54) REFRIGERATOR

(71) Applicant: SAMSUNG ELECTRONICS CO., LTD., Suwon-si (KR)

(72) Inventors: Seungjin LEE, Suwon-si (KR); Dongpil SEO, Suwon-si (KR); Taehyun SUNG, Suwon-si (KR); Dongbum LEE, Suwon-si (KR); Jaebok LEE, Suwon-si (KR)

(73) Assignee: SAMSUNG ELECTRONICS CO., LTD., Suwon-si (KR)

(21) Appl. No.: 19/671,725

(22) Filed: May 8, 2026

Related U.S. Application Data
(63) Continuation of application No. PCT/KR2024/017711, filed on Nov. 11, 2024.

(30) Foreign Application Priority Data
Jan. 5, 2024 (KR) 10-2024-0002507
Apr. 15, 2024 (KR) 10-2024-0050326

(51) Int. Cl. F25B 21/02

(52) U.S. Cl. CPC F25B 21/02; F25B 2321/025; F25B 2700/21

(57) ABSTRACT

A refrigerator includes a storage compartment formed inside a main body, a thermoelectric element configured to cool the storage compartment, a heat sink in contact with the thermoelectric element, the heat sink including a sink base and a plurality of fins protruding from one surface of the sink base, and a temperature sensor configured to measure a temperature of the heat sink, the temperature sensor including a sensor member and a wire. The heat sink includes a sensor receiving groove recessed in the one surface of the sink base, and the sensor member is received in the sensor receiving groove.

### CROSS REFERENCE TO THE RELATED APPLICATION

This application is a continuation application, filed under 35 U.S.C. § 111 (a), of International Application PCT/KR2024/017711 filed Nov. 11, 2024, and is based on and claims priority under 35 U.S.C. § 119 to Korean Patent Applications No. 10-2024-0002507, filed on Jan. 5, 2024 and Korean Patent Applications No. 10-2024-0050326, filed on Apr. 15, 2024 in the Korean Intellectual Property Office, the disclosures of which are incorporated by reference herein in their entireties.

### TECHNICAL FIELD

The present disclosure relates to a refrigerator, and more particularly, to a refrigerator having a thermoelectric module for cooling a storage compartment.

### BACKGROUND ART

A refrigerator is an apparatus keeping food fresh by including a main body having a storage compartment and a cold air supply device for supplying cold air to the storage compartment.

A thermoelectric module generating heating and cooling effects through the Peltier effect of a thermoelectric element may be used as a cold air supply device for a refrigerator. A thermoelectric element has a heat generating portion formed on one side and a heat absorbing portion formed on the opposite side, and when current is applied to the thermoelectric element, heat generation may occur in the heat generating portion and heat absorption may occur in the heat absorbing portion.

A thermoelectric module may include a heat dissipation sink in contact with a heat generating portion and a cooling sink in contact with a heat absorbing portion to increase the efficiency of heat generating and heat absorbing actions of a thermoelectric element. The heat dissipation sink may be provided with a temperature sensor for measuring a temperature of the heat dissipation sink, and the cooling sink may be provided with a temperature sensor for measuring a temperature of the cooling sink.

### DISCLOSURE

### Technical Problem

The present disclosure is directed to providing a thermoelectric module improved such that a temperature sensor is stably fixed to a heat dissipation sink or a cooling sink and a refrigerator having the same.

The present disclosure is directed to providing a thermoelectric module improved such that the accuracy of temperature measurement of a heat dissipation sink or a cooling sink is improved and a refrigerator having the same.

Technical tasks to be achieved in the present disclosure are not limited to the technical tasks mentioned above, and other technical tasks not mentioned will be clearly understood by those skilled in the art from the description below.

### Technical Solution

A refrigerator according to an embodiment of the present disclosure may include: a main body; a storage compartment formed inside the main body; a thermoelectric element configured to cool the storage compartment; a heat sink in contact with the thermoelectric element, the heat sink including a sink base and a plurality of fins protruding from one surface of the sink base; a temperature sensor configured to measure a temperature of the heat sink, the temperature sensor including a sensor member and a wire connected to the sensor member; and a sensor fastening member coupled to the heat sink by penetrating the sensor member to fix the sensor member, wherein the heat sink may include: a sensor receiving groove recessed in the one surface of the sink base, and the sensor member may be received in the sensor receiving groove.

The plurality of fins may include: an outermost fin disposed closest to an edge of the one surface of the sink base among the plurality of fins, and the sensor receiving groove may be formed between the edge of the one surface of the sink base and the outermost fin.

The plurality of fins may protrude in a first direction perpendicular to the one surface of the sink base, the plurality of fins may each extend in a second direction perpendicular to the first direction, and the plurality of fins may be spaced apart from each other along a third direction perpendicular to the first direction and the second direction.

The sensor receiving groove may be formed along the second direction.

The sensor member may have a rectangular parallelepiped shape.

At least three surfaces of the sensor member may be supported by an inner surface of the sensor receiving groove.

The inner surface of the sensor receiving groove may include: a bottom surface; a first surface extending from the bottom surface; and a second surface extending from the bottom surface and parallel to the first surface.

The first surface may be formed on a same plane as a surface of any one of the plurality of fins.

The sensor member may be formed of a same material as the heat sink.

The sensor member may be disposed adjacent to an outermost fin among the plurality of fins.

The sensor member may include: a sensor passing hole through which the sensor fastening member passes.

The heat sink may include: a sensor coupling hole to which the sensor fastening member is coupled.

The sensor fastening member may include: a head; and a fastening member body having a size smaller than a size of the head, and the refrigerator may further include: a rubber ring disposed between the head and the sensor member.

The refrigerator may further include: a thermal conductive tape, the thermal conductive tape including a first portion adhered to at least one surface of the sensor member and a second portion adhered to at least one surface of the heat sink, to fix the sensor member in the sensor receiving groove.

The heat sink may be f extruded along the second direction.

A refrigerator according to an embodiment of the present disclosure may include: a main body; a storage compartment formed inside the main body; a thermoelectric element configured to cool the storage compartment; a heat sink in contact with the thermoelectric element, the heat sink including a sink base and a plurality of fins protruding from one surface of the sink base; and a temperature sensor configured to measure a temperature of the heat sink, the temperature sensor including a sensor member and a wire connected to the sensor member, wherein a plurality of channels may be disposed between the plurality of fins, and the sensor member may be disposed in one surface of the sink base and disposed in any one of the plurality of channels.

The plurality of channels may include: a plurality of basic channels; and at least one wide channel having a width greater than a width of each of the plurality of the basic channels.

Each of the plurality of basic channels may include a first fin and a second fin.

The sensor member may be disposed in the plurality of basic channels and supported between the first fin and the second fin.

The sensor member may be disposed in the at least one wide channel.

The refrigerator may further include: a module plate to support the heat sink; a module fastening member to couple the heat sink and the module plate; and a washer member disposed between a head of the module fastening member and the heat sink, the washer member may be disposed in the wide channel, and the fastening member may be coupled to the washer member.

### Advantageous Effects

According to an embodiment of the present disclosure, a temperature sensor can be stably fixed to a heat dissipation sink or a cooling sink.

According to an embodiment of the present disclosure, the accuracy of temperature measurement of the heat dissipation sink or the cooling sink through the temperature sensor can be improved.

According to an embodiment of the present disclosure, corrosion can be prevented from occurring due to contact between the temperature sensor and the heat dissipation sink or between the temperature sensor and the cooling sink.

Effects obtainable from this disclosure the present disclosure are not limited to the effects mentioned above, and other effects not mentioned will be clearly understood by those skilled in the art to which the present disclosure belongs from the fallowing description.

### DESCRIPTION OF DRAWINGS

FIG. 1 is a view illustrating a refrigerator according to an embodiment of the present disclosure.

FIG. 2 is a view illustrating a state in which doors of the refrigerator are opened according to an embodiment of the present disclosure.

FIG. 3 is a view illustrating a storage compartment of the refrigerator according to an embodiment of the present disclosure.

FIG. 4 is a schematic cross-sectional side view of the refrigerator according to an embodiment of the present disclosure.

FIG. 5 is a cross-sectional view cut along line I-I in FIG. 2.

FIG. 6 is a view illustrating a top cover and a thermoelectric module assembly separated from a main body of the refrigerator according to an embodiment of the present disclosure.

FIG. 7 is a view illustrating a heat dissipation duct cover, a heat dissipation duct body, an extension duct, and a thermoelectric module according to an embodiment of the present disclosure.

FIG. 8 is a bottom perspective view illustrating the heat dissipation duct cover, the heat dissipation duct body, and the thermoelectric module according to an embodiment of the present disclosure.

FIG. 9 is an exploded perspective view illustrating the thermoelectric module according to an embodiment of the present disclosure.

FIG. 10 is a bottom exploded perspective view illustrating the thermoelectric module according to an embodiment of the present disclosure.

FIG. 11 is a cross-sectional view of the heat dissipation duct and the thermoelectric module according to an embodiment of the present disclosure.

FIG. 12 is a perspective view illustrating a combined structure of a temperature sensor and a heat dissipation sink according to an embodiment of the present disclosure.

FIG. 13 is an enlarged view illustrating the temperature sensor according to an embodiment of the present disclosure.

FIG. 14 is a cross-sectional view illustrating the combined structure of the temperature sensor and the heat dissipation sink in FIG. 12.

FIG. 15 is a perspective view illustrating a combined structure of a temperature sensor and a cooling sink according to an embodiment of the present disclosure.

FIG. 16 is a perspective view illustrating a structure in which the temperature sensor is coupled to the heat dissipation sink through a thermal conductive tape according to an embodiment of the present disclosure.

FIG. 17 is a cross-sectional view illustrating a structure in which the temperature sensor in FIG. 16 is coupled to the heat dissipation sink through the thermal conductive tape.

FIG. 18 is a front view illustrating the combined structure of the temperature sensor and the heat dissipation sink according to an embodiment of the present disclosure.

FIG. 19 is a front view illustrating the combined structure of the temperature sensor and the heat dissipation sink according to an embodiment of the present disclosure.

FIG. 20 is an exploded perspective view illustrating the temperature sensor, the heat dissipation sink, and a washer member according to an embodiment of the present disclosure.

FIG. 21 is a cross-sectional view illustrating a combined structure of the temperature sensor, the heat dissipation sink, and the washer member in FIG. 20.

### MODE OF THE DISCLOSURE

Various embodiments of the present disclosure and the terms used therein are not intended to limit the technical features described in the present disclosure to specific embodiments, and should be understood to include various modifications, equivalents, or substitutes of the embodiments.

In connection with the explanation of the drawings, like reference numbers may be used for like or related components.

The singular form of a noun corresponding to an item may include one item or a plurality of items, unless the relevant context clearly dictates otherwise.

In the present disclosure, each of phrases such as “A or B,” “at least one of A and B,” “at least one of A or B,” “A, B or C,” “at least one of A, B and C,” and “at least one of A, B, or C” may include any one of the items listed together in the corresponding one of the phrases, or all possible combinations thereof.

The term “and/or” includes any combination of a plurality of related components or any one of a plurality of related components.

Terms such as “first,” “second,” “primary,” and “secondary” may simply be used to distinguish a given component from other corresponding components, and do not limit the corresponding components in any other aspect (e.g., importance or order).

In the present disclosure, the terms “front surface,” “rear surface,” “upper surface,” “lower surface,” “side surface,” “left side,” “right side,” “upper portion,” and “lower portion” used in the following description are defined based on the drawings, and the shape and position of each component are not limited by these terms.

The terms “includes” and “has” are intended to indicate that there are features, numbers, steps, operations, components, parts, or combinations thereof described in the present disclosure, and do not exclude the presence or addition of one or more other features, numbers, steps, operations, components, parts, or combinations thereof.

When any component is referred to as being “connected,” “coupled”, “supported” or “in contact” with another component, this includes a case in which the components are indirectly connected, coupled, supported, or in contact with each other through a third component as well as directly connected, coupled, supported, or in contact with each other.

When any component is referred to as being located “on” or “above” another component, this includes not only a case in which any component is in contact with another component but also a case in which another component is present between the two components.

A refrigerator according to an embodiment may include a main body.

The main body may include an insulator. The insulator may insulate the inside and outside of a storage compartment so that a temperature inside the storage compartment may be maintained at a set appropriate temperature without being affected by an external environment of the storage compartment. According to an embodiment, the insulator may include a foam insulator such as polyurethane foam. According to an embodiment, the insulator may further include a vacuum insulator in addition to the foam insulator, or may be configured as only the vacuum insulator instead of the foam insulator.

The storage compartment may store various items such as food, medicine, and cosmetics, and may be formed such that at least one side thereof is open to allow items to be put in and to be taken out.

The refrigerator may include one or more storage compartments. When two or more storage compartments are formed in the refrigerator, the respective storage compartments may have different uses and may be maintained at different temperatures. To this end, the respective storage compartments may be partitioned from each other by partitions including the insulators.

The storage compartment may be provided to be maintained at an appropriate temperature range depending on the use, and may include a “refrigerating chamber,” a “freezing chamber,” or a “variable temperature chamber” depending on the use and/or temperature range. The refrigerating chamber may be maintained at an appropriate temperature for storing items in a refrigerated state, and the freezing chamber may be maintained at an appropriate temperature for storing items in a frozen state. “Refrigerating” may refer to cooling items to the point where the items are not frozen, and as an example, the refrigerating chamber may be maintained in a temperature ranging from zero degree Celsius to seven degrees Celsius. “Freezing” may refer to cooling items such that the items are freezing or maintained in a frozen state, as an example, the freezing chamber may be maintained at a temperature ranging from minus twenty degrees Celsius to minus one degree Celsius. The variable temperature chamber may be used as any one of the refrigerating chamber and the freezing chamber, depending on a selection of a user or regardless of the selection of the user.

In addition to names such as “refrigerating chamber,” “freezing chamber,” and “variable temperature chamber,” the storage compartment may be referred to as various names such as “vegetable chamber,” “fresh chamber,” “cooling chamber,” and “ice making chamber,” and terms such as “refrigerating chamber,” “freezing chamber,” and “variable temperature chamber” used below should be understood to encompass storage compartments with corresponding uses and temperature ranges, respectively.

According to an embodiment, the refrigerator may include at least one door configured to open and close the one open side of the storage compartment. The doors may each be provided to open and close the one or more storage compartments, or the one door may be provided to open and close a plurality of the storage compartments. The door may be rotatably or slidingly installed on a front side of the main body.

The door may be configured to seal the storage compartment when closed. Like the main body, the door may include the insulator to insulate the storage compartment when closed.

According to an embodiment, the door may include a door outer plate forming a front surface of the door, a door inner plate forming a rear surface of the door and facing the storage compartment, an upper cap, a lower cap, and a door insulator provided inside the upper and lower caps.

Edges of the door inner plate may be provided with a gasket sealing the storage compartment by coming into close contact with the front side of the main body when the door is closed. The door inner plate may include a dyke protruding rearward so that a door basket for storing items is mounted.

According to an embodiment, the door may include a door body, and a front panel detachably coupled to a front side of the door body and forming the front surface of the door. The door body may include the door outer plate forming a front surface of the door body, the door inner plate forming a rear surface of the door body and facing the storage compartment, the upper cap, the lower cap, and the door insulator provided inside the upper and lower caps.

Refrigerators may be classified into a French door type, a side-by-side type, a bottom mounted freezer (BMF) type, a top mounted freezer (TMF) type, and a one-door refrigerator type depending on the arrangement of doors and storage compartments.

According to an embodiment, the refrigerator may include a cold air supply device configured to supply cold air to the storage compartment.

The cold air supply device may include a machine, mechanism, electronic device, and/or a system combining them capable of generating cold air and guiding the cold air to cool the storage compartment.

According to an embodiment, the cold air supply device may generate cold air through a refrigeration cycle including compression, condensation, expansion, and evaporation processes of a refrigerant. To this end, the cold air supply device may include a refrigeration cycle device having a compressor, a condenser, an expansion device, and an evaporator capable of driving the refrigeration cycle. According to an embodiment, the cold air supply device may include a semiconductor such as a thermoelectric element. The thermoelectric element may cool the storage compartment by generating heat and cooling through the Peltier effect.

According to an embodiment, the refrigerator may include a machine room in which at least some components belonging to the cold air supply device are disposed.

The machine room may be provided to be partitioned and insulated from the storage compartment in order to prevent heat generated from the components disposed in the machine room from being transferred to the storage compartment. The inside of the machine room may be configured to communicate with the outside of the main body to dissipate heat from the components disposed inside the machine room.

According to an embodiment, the refrigerator may include a dispenser provided on the door to provide water and/or ice. The dispenser may be provided on the door such that the user may access the door without opening the door.

According to an embodiment, the refrigerator may include an ice making device provided to produce ice. The ice making device may include an ice making tray provided to store water, an ice moving device provided to separate the ice from the ice making tray, and an ice bucket provided to store the ice produced in the ice making tray.

According to an embodiment, the refrigerator may include a controller configured to control the refrigerator.

The controller may include memory provided to store or remember programs and/or data for controlling the refrigerator, and a processor provided to output a control signal for controlling the cold air supply device and the like according to the programs and/or data stored in the memory.

The memory stores or records a variety of information, data, commands, programs, and the like required for operations of the refrigerator. The memory may remember temporary data generated while generating control signals for controlling components included in the refrigerator. The memory may include at least one of volatile memory and non-volatile memory, or a combination thereof.

The processor controls the overall operation of the refrigerator. The processor may control the components of the refrigerator by executing the programs stored in the memory. The processor may include a separate NPU to perform operations of an artificial intelligence model. The processor may also include a central processor, a graphics processor (GPU), and the like. The processor may generate a control signal for controlling an operation of the cold air supply device. For example, the processor may receive temperature information of the storage compartment from a temperature sensor, and generate a cooling control signal for controlling the operation of the cold air supply device based on the temperature information of the storage compartment.

Additionally, the processor may process user input of a user interface according to the programs and/or data memorized/stored in the memory and control an operation of the user interface. The user interface may be provided using an input interface and an output interface. The processor may receive the user input from the user interface. The processor may also transmit a display control signal and image data for displaying an image on the user interface to the user interface in response to the user input.

The processor and the memory may be provided integrally or may be provided separately. The processor may include one or more processors. For example, the processor may include a main processor and at least one sub-processor. The memory may include one or more memories.

According to an embodiment, the refrigerator may include a processor and a memory to control all the components included in the refrigerator, and may include a plurality of processors and a plurality of memories to individually control the components of the refrigerator. For example, the refrigerator may include a processor and memory to control the operation of the cold air supply device depending on output of the temperature sensor. Also, the refrigerator may be separately equipped with a processor and memory to control the operation of the user interface according to user input.

A communication module may communicate with an external device such as a server, a mobile device, and another home appliance through a nearby access point (AP). The access point (AP) may connect a local area network (LAN) to which the refrigerator or a user device is connected to a wide area network (WAN) to which the server is connected. The refrigerator or the user device may be connected to the server via the wide area network (WAN).

The input interface may include a key, a touch screen, a microphone, and the like. The input interface may receive user input and transmit the user input to the processor.

The output interface may include a display, a speaker, and the like. The output interface may output various notifications, messages, a variety of information, and the like generated by the processor.

Hereinafter, embodiments of the present disclosure will be described in detail with reference to the accompanying drawings.

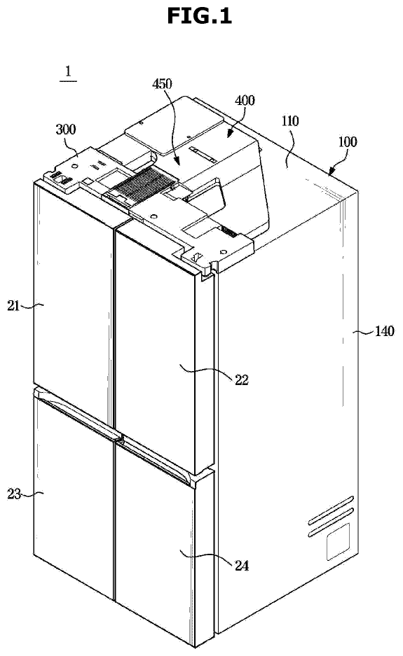

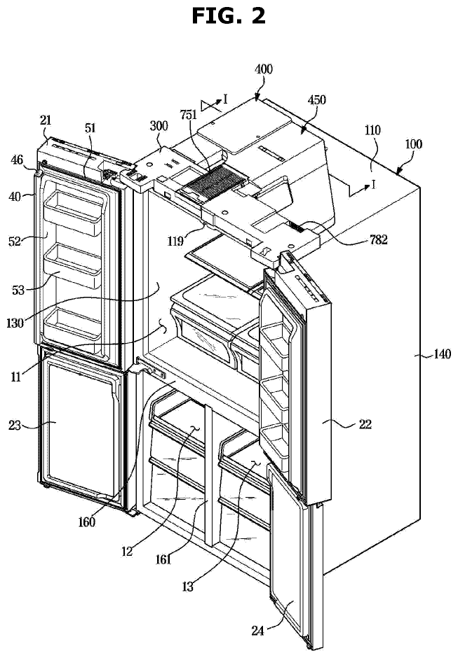

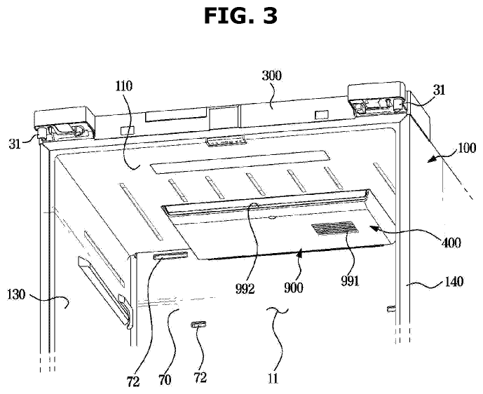

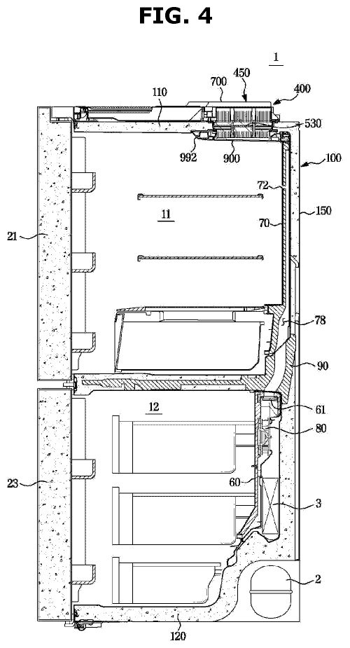

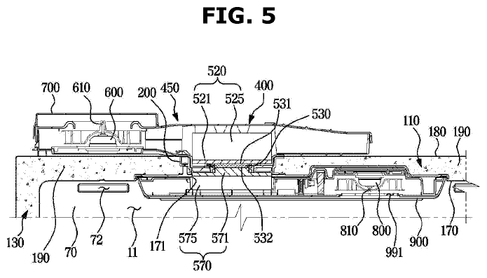

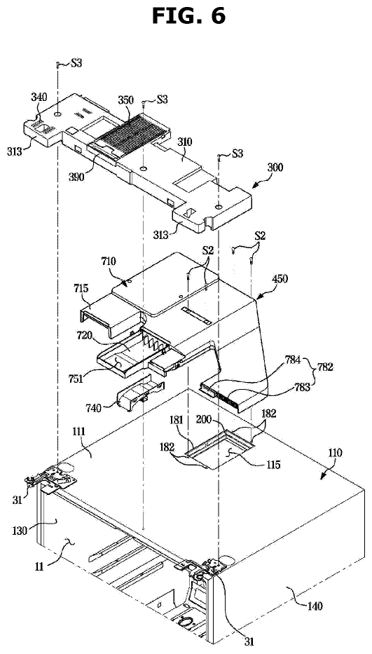

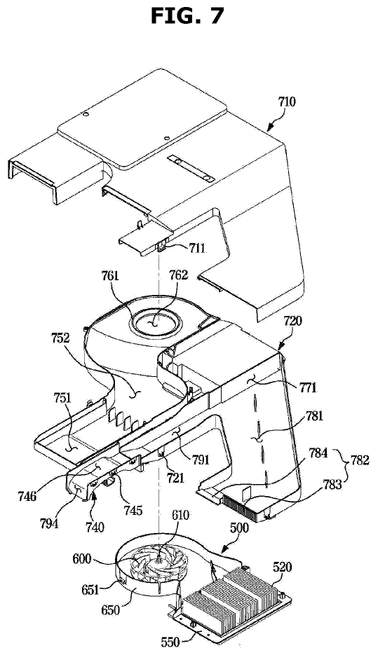

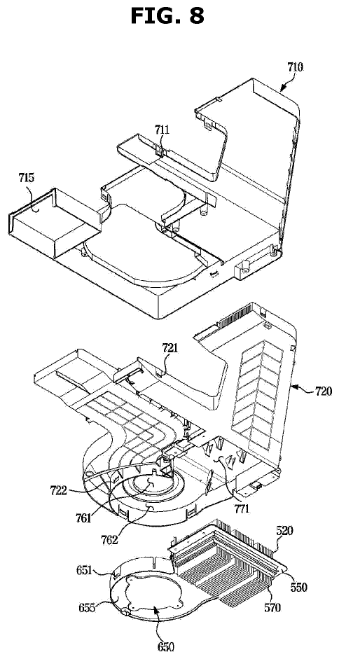

FIG. 1 is a view illustrating a refrigerator according to an embodiment of the present disclosure. FIG. 2 is a view illustrating a state in which doors of the refrigerator are opened according to an embodiment of the present disclosure. FIG. 3 is a view illustrating a storage compartment of the refrigerator according to an embodiment of the present disclosure. FIG. 4 is a schematic cross-sectional side view of the refrigerator according to an embodiment of the present disclosure. FIG. 5 is a cross-sectional view cut along line I-I in FIG. 2. FIG. 6 is a view illustrating a top cover and a thermoelectric module assembly separated from a main body of the refrigerator according to an embodiment of the present disclosure. FIG. 7 is a view illustrating a heat dissipation duct cover, a heat dissipation duct body, an extension duct, and a thermoelectric module according to an embodiment of the present disclosure. FIG. 8 is a bottom perspective view illustrating the heat dissipation duct cover, the heat dissipation duct body, and the thermoelectric module according to an embodiment of the present disclosure.

Referring to FIGS. 1 to 8, a refrigerator 1 may include a main body 100, storage compartments 11, 12, and 13 formed inside the main body 100, and doors 21, 22, 23, and 24 provided to open and close the storage compartments 11, 12, and 13.

The main body 100 may include an inner case 170, an outer case 180 coupled to an outer side of the inner case 170, and an insulator 190 provided between the inner case 170 and the outer case 180. The inner case 170 may form the storage compartments 11, 12, and 13, and the outer case 180 may form an outer appearance of the main body 100. The insulator 190 may be a urethane foam insulator.

In another aspect, the main body 100 may include an upper wall 110, a lower wall 120, a left wall 130, a right wall 140, and a rear wall 150. The upper wall 110, the lower wall 120, the left wall 130, the right wall 140, and the rear wall 150 may form an upper surface 111, a lower surface, a left surface, a right surface, and the rear wall of the main body 100, respectively.

The upper wall 110, the lower wall 120, the left wall 130, the right wall 140, and the rear wall 150 may each be composed of the inner case 170, the outer case 180, and the insulator 190. As an example, the upper surface 111 of the upper wall 110 may be formed by the outer case 180, a lower surface of the upper wall 110 may be formed by the inner case 170, and the insulator 190 may be provided inside the upper wall 110.

The upper wall 110 may include an installation hole 115 (FIG. 6). The storage compartment 11 and the inside of the main body 100 may be connected through the installation hole 115. At least a portion of a thermoelectric module 500, which will be described later, may be disposed inside the installation hole 115. The thermoelectric module 500 may be disposed to pass through the installation hole 115.

The storage compartments 11, 12, and 13 may accommodate items. The storage compartments 11, 12, and 13 may be formed with an open front side to allow items to be put in or taken out. The main body 100 may include a horizontal partition wall 160 provided to partition the storage compartments 11, 12, and 13 into the upper first storage compartment 11 and the lower storage compartments 12 and 13, and a vertical partition wall 161 provided to partition the lower storage compartments 12 and 13 into the second storage compartment 12 and the third storage compartment 13. The first storage compartment 11 may be a refrigerating chamber, the second storage compartment 12 may be a freezing chamber, and the third storage compartment 13 may be a variable temperature chamber.

The doors 21, 22, 23, and 24 may open and close the storage compartments 11, 12, and 13. The first door 21 and the second door 22 may open and close the first storage compartment 11, the third door 23 may open and close the second storage compartment 12, and the fourth door 24 may open and close the third storage compartment 13. The doors 21, 22, 23, and 24 may be rotatably coupled to the main body 100.

The doors 21, 22, 23, and 24 may be rotatably coupled to the main body 100 by hinges. For example, the first door 21 and the second door 22 may each be rotatably coupled to the main body 100 by a hinge 31 provided on an upper portion of the main body 100 and a hinge provided in a middle of the main body 100. The hinge 31 may include a hinge pin protruding in a vertical direction to form a rotational axis of the door. The hinge 31 may be covered by a top cover 300 provided to cover a front portion of the upper surface 111 of the main body 100.

One of the first door 21 and the second door 22 may be provided with a rotating bar 40 for covering a gap formed between the first door 21 and the second door 22 when the first door 21 and the second door 22 are closed. The rotating bar 40 may be provided to be rotatable on one of the first door 21 and the second door 22. The rotating bar 40 may have a rod shape formed to be long in the vertical direction. The rotating bar 40 may also be referred to as a pillar, a mullion, etc.

A guide protrusion 46 may be provided at an upper end of the rotating bar 40, and a rotation guide 119 may be provided at the upper portion of the main body 100 to guide the rotation of the guide protrusion 46.

The doors 21, 22, 23, and 24 may include gaskets 51. The gaskets 51 may be provided on rear surfaces of the doors 21, 22, 23, and 24. The gaskets 51 may be in close contact with a front surface of the main body 100 when the doors 21, 22, 23, and 24 are closed. The doors 21, 22, 23, and 24 may include a dyke 52 protruding rearward. A door shelf 53 capable of storing items may be mounted on the dyke 52. The rotating bar 40 may be rotatably installed on the dyke 52.

Although the number and arrangement of storage compartments and the number and arrangement of doors have been described above, there is no limitation on the number and arrangement of storage compartments and the number and arrangement of doors of the refrigerator according to an embodiment of the present disclosure.

The refrigerator 1 may include a thermoelectric cooling device 400 configured to cool the storage compartment 11.

The thermoelectric cooling device 400 may be provided on an upper side of the storage compartment 11 to cool the storage compartment 11. That is, the thermoelectric cooling device may be provided on the upper wall 110 of the main body 100.

The thermoelectric cooling device 400 may include a thermoelectric module assembly 450. The thermoelectric module assembly 450 may include a thermoelectric module 500 and a heat dissipation duct 700. The thermoelectric module 500 and the heat dissipation duct 700 may be assembled together to form the thermoelectric module assembly 450.

The thermoelectric module assembly 450 may be coupled to the upper wall 110 of the main body 100 in a downward direction from above. After the thermoelectric module assembly 450 is coupled to the upper wall 110 of the main body 100 in the downward direction from above, a cooling duct 900, which will be described later, may be coupled to the lower surface of the upper wall 110 of the main body 100 in an upward direction from below.

The thermoelectric module assembly 450 may be coupled to the upper wall 110 of the main body 100 by at least one fastening member S2 (FIG. 6). The at least one fastening member S2 may be a mechanical element for coupling, such as a screw, a bolt, or the like.

The thermoelectric module 500 may include a thermoelectric element 530, a heat sink, and a module plate 550. The heat sink may include a heat dissipation sink 520 and a cooling sink 570.

The thermoelectric element 530 may be a semiconductor element that converts thermal energy into electrical energy using the thermoelectric effect, and may also be referred to as a thermoelectric semiconductor element, a Peltier element, etc.

The thermoelectric element 530 may include a heat generating portion 531 and a heat absorbing portion 532. When current is applied to the thermoelectric element 530, heat generation may occur in the heat generating portion 531 and heat absorption may occur in the heat absorbing portion 532. The thermoelectric element 530 may have a thin hexahedral shape. The heat generating portion 531 may be provided on one surface of the thermoelectric element 530, and the heat absorbing portion 532 may be provided on the opposite surface.

The thermoelectric element 530 may be provided on the upper wall 110 such that the heat generating portion 531 faces upward of the thermoelectric element 530 and the heat absorbing portion 532 faces downward of the thermoelectric element 530. That is, the heat generating portion 531 may face the outside of the main body 100, and the heat absorbing portion 532 may face the inside of the storage compartment 11 through the installation hole 115 of the upper wall 110. Accordingly, the air that has been warmed by heat exchange with the heat generating portion 531 may be discharged to the outside of the main body 100, and the air that has been cooled by heat exchange with the heat absorbing portion 532 may be supplied to the storage compartment 11 to cool the storage compartment 11.

The heat dissipation sink 520 may be in contact with the heat generating portion 531 to absorb heat from the heat generating portion 531 and dissipate heat to the outside of the main body 100. The heat dissipation sink 520 may also be referred to as a hot sink, a heat dissipation heat sink, a hot heat sink, etc.

The heat dissipation sink 520 may be formed of a metal material with high thermal conductivity. For example, the heat dissipation sink 520 may be formed of aluminum or copper.

The heat dissipation sink 520 may include a heat dissipation sink base 521 in contact with the heat generating portion 531 and a plurality of heat dissipation fins 525 protruding from the heat dissipation sink base 521 to expand a heat transfer area.

The heat dissipation sink base 521 may be disposed horizontally, and the plurality of heat dissipation fins 525 may protrude upward from the heat dissipation sink base 521. The heat dissipation sink base 521 and the plurality of heat dissipation fins 525 may be formed integrally.

The cooling sink 570 may cool the storage compartment 11 by taking away heat from the storage compartment 11 and transferring the heat to the heat absorbing portion 532. The cooling sink 570 may also be referred to as a cold sink, cooling sink, cooling heat sink, cold heat sink, cooling heat sink, etc.

The cooling sink 570 may be formed of a metal material with high thermal conductivity. For example, the cooling sink 570 may be formed of aluminum or copper.

The cooling sink 570 may include a cooling sink base 571 in contact with the heat absorbing portion 532 and a plurality of cooling fins 575 protruding from the cooling sink base 571 to expand a heat transfer area. The cooling sink base 571 may be disposed horizontally, and the plurality of cooling fins 575 may protrude downward from the cooling sink base 571. The cooling sink base 571 and the plurality of cooling fins 575 may be formed integrally.

The module plate 550 may support the heat dissipation sink 520 and the cooling sink 570. The heat dissipation sink 520 may be disposed on one side of the module plate 550, and the cooling sink 570 may be disposed on the other side of the module plate 570. That is, the heat dissipation sink 520 may be disposed on an upper side of the module plate 550, and the cooling sink 570 may be disposed on a lower side of the module plate 550.

The thermoelectric module 500 may include a heat dissipation fan 600 provided to flow air in order to efficiently exchange heat between the heat dissipation sink 520 and air outside the main body 100. The heat dissipation fan 600 may be provided to blow air toward the heat dissipation sink 520. The heat dissipation fan 600 may be provided to be positioned horizontally with respect to the heat dissipation sink 520.

The heat dissipation fan 600 may be a centrifugal fan that draws in air in an axial direction and discharges the air in radial directions. The centrifugal fan may include a blower fan. A rotating shaft 610 of the heat dissipation fan 600 may be disposed vertically. The heat dissipation fan 600 may be installed in a fan case 650. The fan case 650 and the module plate 550 may be formed integrally. However, unlike the present embodiment, the fan case 650 and the module plate 550 may be formed separately.

The heat dissipation duct 700 may guide air outside the main body 100 to exchange heat with the heat dissipation sink 520, and guide air that has exchanged heat with the heat dissipation sink 520 to be discharged back to the outside of the main body 100.

The heat dissipation duct 700 may be coupled to an upper side of the thermoelectric module 500. A heat dissipation duct body 720 may be provided with a duct coupling portion 722, and the thermoelectric module 500 may be provided with a module coupling portion 651. The duct coupling portion 722 and the module coupling portion 651 may be coupled in a hook or fitting manner. FIGS. 7 and 8 illustrate that the module coupling portion 651 is provided on the fan case 650, but the module coupling portion 651 may also be provided on the module plate 550.

The heat dissipation duct 700 may include the heat dissipation duct body 720, a heat dissipation duct cover 710, and an extension duct 740.

The heat dissipation duct cover 710 may be coupled to an upper portion of the heat dissipation duct body 720 to cover an upper side of the heat dissipation duct body 720. The heat dissipation duct cover 710 may be provided with a duct cover coupling portion 711, and the heat dissipation duct body 720 may be provided with a duct body coupling portion 721 coupled to the duct cover coupling portion 711. The duct cover coupling portion 711 and the duct body coupling portion 721 may be coupled in a hook or fitting manner.

The extension duct 740 may be provided at the front of the heat dissipation duct body 720 to be connected to the heat dissipation duct body 720. The extension duct 740 may be formed separately from the heat dissipation duct body 720. However, unlike this, the extension duct 740 may also be formed integrally with the heat dissipation duct body 720.

The extension duct 740 may be disposed below the top cover 300 and coupled to a lower portion of the top cover 300. To this end, the extension duct 740 may be provided with an extension duct coupling portion 745 coupled to the top cover 300.

The heat dissipation duct body 720 may be provided on the upper side of the thermoelectric module 500 to cover the heat dissipation fan 600 and the heat dissipation sink 520. An outside air intake hole 751 may be formed on an upper side of a front portion of the heat dissipation duct body 720, and the outside air intake hole 751 may be covered by the top cover 300, which will be described later.

The heat dissipation duct 700 may include outside air discharge holes 782 and 794 provided to allow air that has exchanged heat with the heat dissipation sink 520 to be discharged to the outside of the main body 100. The outside air discharge holes 782 and 794 may include the first outside air discharge hole 782 provided to allow warm air that has exchanged heat with the heat dissipation sink 520 to be discharged to the outside of the main body 100, and the second outside air discharge hole 794 provided to allow the warm air to be discharged toward the rotating bar 40.

The heat dissipation duct body 720 may include the first outside air discharge hole 782. The first outside air discharge hole 782 may include a connection port 784 provided to guide air inside the heat dissipation duct 700 to the inside of the top cover 300, and an outside discharge hole 783 provided to be partitioned from the connection port 784 in order to allow air in the heat dissipation duct 700 to be discharged to the outside of the top cover 300.

High temperature air guided into the inside of the top cover 300 through the connection port 784 may heat the upper surface 111 of the main body 100 while passing through the inside of the top cover 300. Accordingly, condensation may be prevented from occurring on an upper portion of the front surface of the main body 100.

A grill may be formed in the outside discharge hole 783 to prevent foreign substances from being introduced into the inside of the heat dissipation duct 700 through the outside discharge hole 783.

The extension duct 740 may include the second outside air discharge hole 794. High temperature air discharged toward the rotating bar 40 through the second outside air discharge hole 794 may heat the rotating bar 40. Accordingly, condensation may be prevented from occurring on the rotating bar 40.

However, the heat dissipation duct 700 does not have to include both the first outdoor air discharge hole 782 and the second outdoor air discharge hole 794, and depending on an embodiment, the second outdoor air discharge hole 794 may be omitted.

Also, the first outside air discharge hole 782 of the heat dissipation duct 700 does not have to include both the connection port 784 and the outside discharge hole 783, and depending on an embodiment, the connection port 784 may be omitted.

The heat dissipation duct body 720 may include a fan accommodation space 762 provided to accommodate the heat dissipation fan 600. The fan accommodation space 762 may be formed on a bottom surface of the heat dissipation duct body 720. The heat dissipation duct body 720 may include a fan inlet 761 through which air is drawn into the fan accommodation space 762.

The heat dissipation duct body 720 may include a sink accommodation space 771 formed on a downstream side of the fan accommodation space 762 to accommodate the heat dissipation sink 520.

The heat dissipation duct body 720 may include an intake space 752 formed on an upper surface of the heat dissipation duct body 720 to guide air drawn in through the outside air intake hole 751 to the fan accommodation space 762. An upper side of the intake space 752 may be formed to be open, and the open upper side of the intake space 752 may be covered by the heat dissipation duct cover 710. The intake space 752 may be formed on an upstream side of the fan accommodation space 762. The intake space 752 may be connected to the fan accommodation space 762 through the fan inlet 761.

The heat dissipation duct body 720 may include a first discharge space 781 formed on the upper surface of the heat dissipation duct body 720 to guide air that has exchanged heat with the heat dissipation sink 520 to the first outdoor air discharge hole 782. An upper side of the first discharge space 781 may be open, and the open upper side of the first discharge space may be covered by the heat dissipation duct cover 710. The first discharge space 781 may be formed on a downstream side of the sink accommodation space 771.

The heat dissipation duct body 720 may include a second discharge space 791 formed on the upper surface of the heat dissipation duct body 720 to guide air that has exchanged heat with the heat dissipation sink 520 to the second outdoor air discharge hole 794. An upper side of the second discharge space 791 may be open, and the open upper side of the second discharge space 791 may be covered by the heat dissipation duct cover 710. The second discharge space 791 may be formed on the downstream side of the sink accommodation space 771.

The extension duct 740 may include an extension discharge space 746 connected to the second discharge space 791 of the heat dissipation duct body 720. Air in the second discharge space 791 may be guided to the second outdoor air discharge hole 794 through the extension discharge space 746.

The refrigerator 1 may include the top cover 300 coupled to the front portion of the upper surface 111 of the main body 100 to cover a plurality of the hinges 31. After the thermoelectric module assembly 450 is coupled to the upper wall 110 of the main body 100, the top cover 300 may be coupled to the upper wall 110 of the main body 100. When the top cover 300 is coupled to the upper wall 110 of the main body 100, the top cover 300 may press a front end of the thermoelectric module assembly 450 downward. Accordingly, the thermoelectric module assembly 450 may be more stably coupled to the upper wall 110. The top cover 300 may be coupled to the upper wall 110 of the main body 100 through at least one fastening member S3.

The thermoelectric cooling device 400 may include a dust filter 390 arranged to filter out foreign substances from air being introduced into the outside air intake hole 751. The dust filter 390 may be slidably mounted on the top cover 300 in a front-rear direction.

The top cover 300 may include an intake grill portion 350 formed on an upper surface portion 310 of the top cover. The intake grill portion 350 may be positioned on an upper side of the dust filter 390. The intake grill portion 350 my primarily block foreign substances from being drawn into the inside of the heat dissipation duct 700 before the dust filter 390. The intake grill portion 350 may protect the dust filter 390 by preventing an external force from being applied to the dust filter 390.

The top cover 300 may include front protrusion portions 313 protruding forward from both ends of the top cover 300 to cover the plurality of hinges 31. A top cover discharge hole 340 may be formed on the front protrusion portion 313 to allow air inside the top cover 300 to be discharged to the outside of the top cover 300.

Air in the heat dissipation duct 700 may be introduced into the inside of the top cover 300 through the connection port 784. The air introduced into the inside of the top cover 300 may heat the upper surface 111 of the main body 100 and may be discharged to the outside of the top cover 300 through the top cover discharge hole 340.

The thermoelectric cooling device 400 may include a cooling fan 800 provided to flow air in order to efficiently exchange heat between the cooling sink 570 and air inside the storage compartment 11.

The cooling fan 800 may be provided to blow air toward the cooling sink 570. The cooling fan 800 may be provided to be positioned horizontally with respect to the cooling sink 570. The cooling fan 800 may be provided inside the storage compartment 11. The cooling fan 800 may be provided on a lower side of the upper wall 110.

The cooling fan 800 may be a centrifugal fan that draws in air in an axial direction and discharges the air in radial directions. A rotating shaft 810 of the cooling fan 800 may be disposed vertically on a bottom surface of the upper wall 110.

The thermoelectric cooling device 400 may include the cooling duct 900 provided to guide air flowing by the cooling fan 800. The cooling device 400 may guide air inside the storage compartment 11 to exchange heat with the cooling sink 570, and guide air that has exchanged heat with the cooling sink 570 to be discharged back to the inside of the storage compartment 11.

The cooling fan 800 may be positioned inside the cooling duct 900. The cooling sink 570 may be positioned inside the cooling duct 900 by penetrating an upper portion of the cooling duct 900. The cooling duct 900 may be coupled to the lower surface of the upper wall 110.

The cooling duct 900 may include an inside air intake hole 991 provided to allow air inside the storage compartment 11 to be drawn into the inside of the cooling duct 900, and an inside air discharge hole 992 provided to allow air that has exchanged heat with the cooling sink 570 to be discharged into the inside of the storage compartment 11.

The refrigerator 1 may include a refrigeration cycle device to cool the storage compartment through a refrigeration cycle. The refrigeration cycle device may include a compressor 2, a condenser (not shown), an expansion device (not shown), and an evaporator 3. The evaporator 3 may be provided at rear sides of the storage compartments 12 and 13.

The refrigerator 1 may include evaporator ducts 60 and 70 provided to guide cold air generated in the evaporator 3. The first evaporator duct 60 may be provided at the rear sides of the second storage compartment 12 and third storage compartment 13. The second evaporator duct 70 may be provided at a rear side of the first storage compartment 11.

The cold air generated in the evaporator 3 may be drawn into the inside of the first evaporator duct 60 by the evaporator fan 80. The cold air drawn into the inside of the first evaporator duct 60 may be discharged to the second storage compartment 12 or the third storage compartment 13 through a cold air discharge hole (not shown) formed at a front surface thereof. Additionally, the cold air drawn into the inside of the first evaporator duct 60 may be guided to an internal flow path 78 of the second evaporator duct 70. A damper 61 may be provided in the first evaporator duct 60 to control the supply of cold air inside the first evaporator duct 60 to the second evaporator duct 70. A connection duct 90 may be provided between the first evaporator duct 60 and the second evaporator duct 70 to connect the first evaporator duct 60 and the second evaporator duct 70.

The cold air introduced into the internal flow path 78 of the second evaporator duct 70 may be supplied to the first storage compartment 11 through a cold air discharge hole 72 formed at a front surface of the second evaporator duct 70.

As such, according to an embodiment of the present disclosure, the refrigerator may include the thermoelectric cooling device 400 and the refrigeration cycle device, but is not limited thereto, and the refrigerator may include only the thermoelectric cooling device 400.

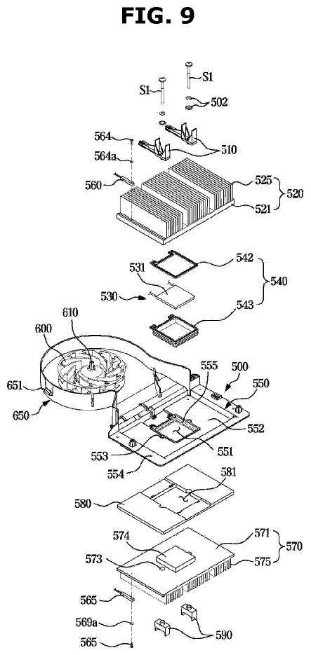

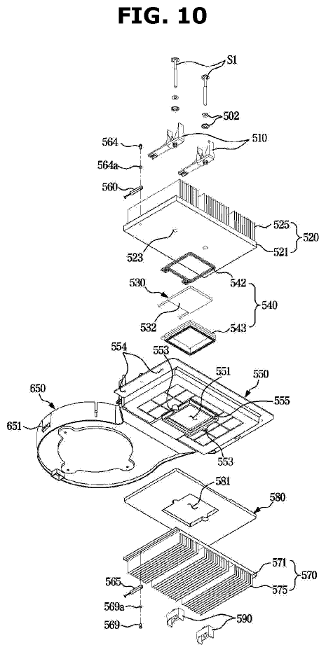

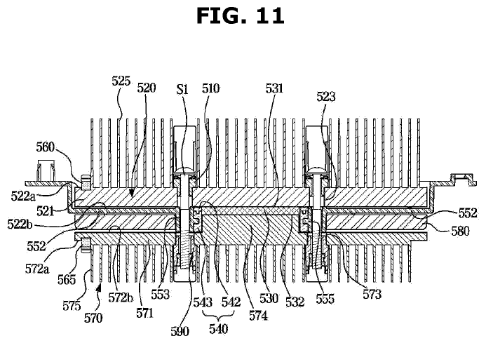

FIG. 9 is an exploded perspective view illustrating the thermoelectric module according to an embodiment of the present disclosure. FIG. 10 is a bottom exploded perspective view illustrating the thermoelectric module according to an embodiment of the present disclosure. FIG. 11 is a cross-sectional view of the thermoelectric module according to an embodiment of the present disclosure.

The thermoelectric module 500 may include the thermoelectric element 530 having the heat generating portion 531 and the heat absorbing portion 532, the heat dissipation sink 520 in contact with the heat generating portion 531 of the thermoelectric element 530, the cooling sink 570 in contact with the heat absorbing portion 532 of the thermoelectric element 530, and the module plate 550 on which the thermoelectric element 530, the heat dissipation sink 520, and the cooling sink 570 are installed.

The module plate 550 may serve as a skeleton of the thermoelectric module 500. The module plate 550 may be formed of a resin material with low thermal conductivity. The module plate 550 may support the heat dissipation sink 520 and the cooling sink 570. The module plate 550 may maintain a gap between the heat dissipation sink 520 and the cooling sink 570.

The module plate 550 may include a plate base 552. The plate base 552 may be provided horizontally. The plate base 552 may support the heat dissipation sink 520. The plate base 552 may be in contact with a bottom surface of the heat dissipation sink base 521 support the heat dissipation sink 520. The plate base 552 may have a size and shape corresponding to the heat dissipation sink 520. The plate base 552 may have a quadrangular shape.

The module plate 550 may include a module plate opening 551. The module plate 550 may include an element mounting portion 555 forming the module plate opening 551. The element mounting portion 555 may protrude from a lower surface of the plate base 552.

The thermoelectric element 530 may be disposed inside the module plate opening 551. A length of the module plate opening 551 in an up-down direction (i.e., a length of the element mounting portion 555 in the up-down direction) may be longer than a length of the thermoelectric element 530 in the up-down direction, and the thermoelectric element 530 may be disposed close to an upper end of the module plate opening 551.

The reason why the thermoelectric element 530 is disposed at the upper end of the inside of the module plate opening 551 is that, typically, a heat generation amount of the thermoelectric element 530 may be larger than a heat absorption amount thereof, and the positioning of the thermoelectric element 530 at the upper end of the module plate opening 551 may be advantageous for heat dissipation of the heat generating portion 531, and the overall operating efficiency of the thermoelectric element 530 may be increased.

Because the thermoelectric element 530 is disposed at the upper end of the module plate opening 551, the cooling sink 570 may include a cooling conductive part 574 protruding from the cooling sink base 571 to be in contact with the heat absorbing portion 532 of the thermoelectric element 530. The cooling conduction part 574 may be formed integrally with the cooling sink base 571. The cooling conductive part 574 may be inserted into the module plate opening 551 from below upwards to come into contact with the heat absorbing portion 532 of the thermoelectric element 530.

The thermoelectric module 500 may include an element insulator 540 provided to insulate the module plate 550 and the thermoelectric element 530. The element insulator 540 may be disposed in the module plate opening 551 to prevent the thermoelectric element 530 from being in contact with the module plate 550. The element insulator 540 may be provided to surround a side surface of the thermoelectric element 530. The element insulator 540 may include an element insulator body 543 and an element insulator cover 542 coupled to an upper side of the element insulator body 543. The element insulator 540 may be formed of a resin material having low thermal conductivity. As an example, the element insulator 540 may be formed of a silicone material.

The thermoelectric module 500 may include a sink insulator 580 provided between the module plate 550 and the cooling sink 570. The sink insulator 580 may prevent heat from being transferred between the heat dissipation sink 520 and the cooling sink 570 through the module plate 550. The sink insulator 580 may include a sink insulator opening 581.

The sink insulator 580 may support an upper surface of the cooling sink 570. However, depending on an embodiment, the sink insulator 580 may be omitted, and in this case, the cooling sink 570 may be supported by being in contact with a bottom surface of the module plate 550. Alternatively, the sink insulator 580 may be provided between the heat dissipation sink 520 and the module plate 550.

The heat dissipation sink 520 and the cooling sink 570 may be coupled to the module plate 550 through a fastening member S1. The fastening member S1 may be a mechanical element for coupling, such as a screw, bolt, etc.

A heat dissipation sink passing hole 523 may be formed on the heat dissipation sink 520 to allow the fastening member S1 to pass through. A plate passing hole 553 may be formed on the module plate 550 to allow the fastening member S1 to pass through. A cooling sink passing hole 573 may be formed on the cooling sink 570 to allow the fastening member S1 to pass through.

The thermoelectric module 500 may include a washer member 510 supported between a head of the fastening member S1 and the heat dissipation sink 520. As the washer member 510 is provided between the head of the fastening member S1 and the heat dissipation sink 520, the washer member 510 may prevent the fastening member S1 and the heat dissipation sink 520 from being in contact with each other and reduce heat of the heat dissipation sink 520 from being transferred through the fastening member S1. The washer member 510 may be formed of a plastic material having low thermal conductivity. The washer member 510 may be injection molded of a resin material.

A loosening prevention member 502 may be provided between the head of the fastening member S1 and the washer member 510 to prevent loosening of the fastening member S1.

The thermoelectric module 500 may include a nut member 590 by which an end opposite the head of the fastening member S1 is fastened. The nut member 590 may be supported on the cooling sink 570. The nut member 590 may be provided between the end opposite the head of the fastening member S1 and the cooling sink 570 to prevent the fastening member S1 and the cooling sink 570 from being in contact with each other and reduce cold air of the cooling sink 570 from being transferred through the fastening member S1. The nut member 590 may be formed of a plastic material to reduce heat transfer between the fastening member S1 and the cooling sink 570.

When the heat dissipation sink 520 and the cooling sink 570 are coupled to the module plate 550 through the fastening member S1, the heat dissipation sink 520 and the cooling sink 570 may be coupled to the module plate 550 through the fastening member S1 in a state in which the element insulator 540 and the thermoelectric element 530 are disposed in the opening 551 of the module plate 550. Therefore, the thermoelectric element 530 may be fixed simultaneously while the heat dissipation sink 520 and the cooling sink 570 are fixed to the module plate 550.

The heat generating portion 531 of the thermoelectric element 530 may be supported by and fixed to the heat dissipation sink 520, the heat absorbing portion 532 of the thermoelectric element 530 may be supported by and fixed to the cooling sink 570, and a side surface connecting the heat generating portion 531 and the heat absorbing portion 532 of the thermoelectric element 530 may be supported by and fixed to an inner surface of the element insulator 540.

As such, the heat dissipation sink 520 and the cooling sink 570 may be easily assembled to the module plate 550 by the fastening member S1. In addition, because the heat dissipation sink 520 and the heat generating portion 531 of the thermoelectric element 530 may be in close contact with each other, and the cooling sink 570 and the heat absorbing portion 532 of the thermoelectric element 530 may be in close contact with each other, the efficiency of the thermoelectric module 500 may be increased by efficiently performing the heat exchange between the heat dissipation sink 520 and the heat generating portion 531 of the thermoelectric element 530 and the heat exchange between the cooling sink 570 and the heat absorbing portion 532 of the thermoelectric element 530.

The thermoelectric module 500 may include a temperature sensor 560 provided to measure a temperature of the heat dissipation sink 520. The thermoelectric module 500 may include a temperature sensor 565 provided to measure a temperature of the cooling sink 570. The refrigerator 1 may control output of the thermoelectric element 530 by adjusting a voltage to be supplied to the thermoelectric element 530 based on information about the temperature of the heat dissipation sink 520 measured through the temperature sensor 560 or information about the temperature of the cooling sink 570 measured through the temperature sensor 565.

The temperature sensor 560 may be coupled to the heat dissipation sink 520 through a sensor fastening member 564. A rubber ring 564a may be provided between the temperature sensor 560 and the sensor fastening member 564 to reduce vibration. However, depending on an embodiment, the rubber ring 564a may be omitted.

The temperature sensor 565 may be coupled to the cooling sink 570 by a sensor fastening member 569. A rubber ring 569a may be provided between the temperature sensor 565 and the sensor fastening member 569 to reduce vibration. However, depending on an embodiment, the rubber ring 569a may be omitted.

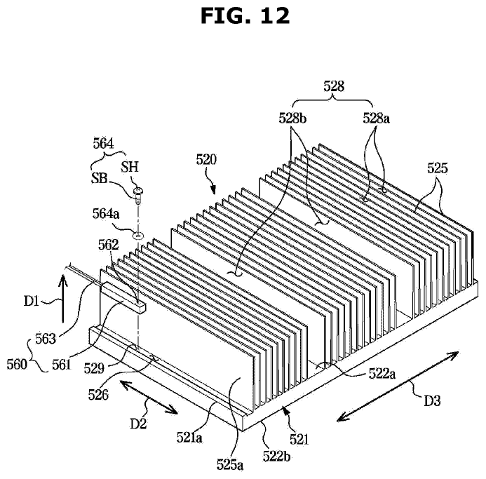

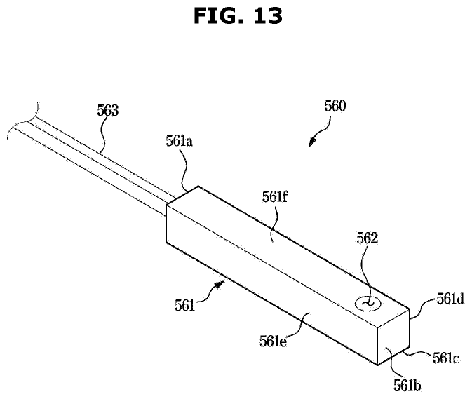

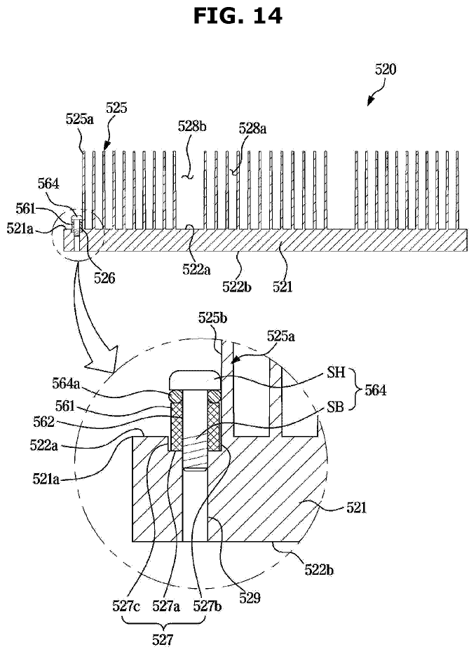

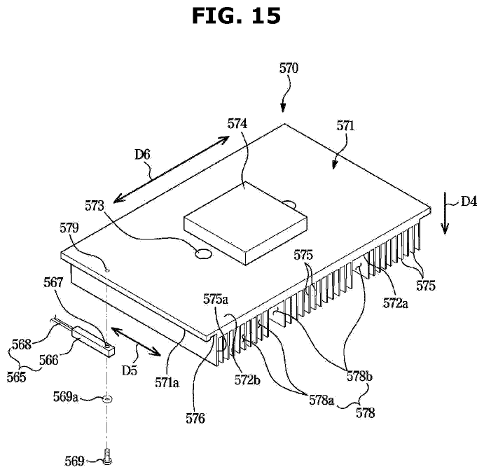

FIG. 12 is a perspective view illustrating a combined structure of a temperature sensor and a heat dissipation sink according to an embodiment of the present disclosure. FIG. 13 is an enlarged view illustrating the temperature sensor according to an embodiment of the present disclosure. FIG. 14 is a cross-sectional view illustrating the combined structure of the temperature sensor and the heat dissipation sink in FIG. 12. FIG. 15 is a perspective view illustrating a combined structure of a temperature sensor and a cooling sink according to an embodiment of the present disclosure.

Referring to FIGS. 12 to 15, the heat dissipation sink base 521 may include one surface 522a and an opposite surface 522b opposite to the one surface 522a. The one surface 522a may face upward of the heat dissipation sink base 521, and the other surface 522b may face downward of the heat dissipation sink base 521.

The plurality of heat dissipation fins 525 may protrude from the one surface 522a of the heat dissipation sink base 521. The other surface 522b of the heat dissipation sink base 521 may be in contact with the thermoelectric element 530.

The plurality of heat dissipation fins 525 may protrude from the one surface 522a of the heat dissipation sink base 521. The plurality of heat dissipation fins 525 may protrude in a direction D1 perpendicular to the one surface 522a of the heat dissipation sink base 521. The plurality of heat dissipation fins 525 may be formed to extend in a direction D2 parallel to the one surface 522a of the heat dissipation sink base 521. The plurality of heat dissipation fins 525 may be arranged in one direction D3 to be spaced apart from each other. The direction D3 in which the plurality of heat dissipation fins 525 is arranged may be orthogonal to the direction D1 in which the plurality of heat dissipation fins 525 protrudes and the direction D2 in which the plurality of heat dissipation fins 525 extends.

Heat dissipation channels 528 may be formed between the adjacent plurality of heat dissipation fins 525. The heat dissipation channels 528 may include basic heat dissipation channels 528a and at least one wide heat dissipation channel 528b having a width greater than widths of the basic heat dissipation channels 528a. That is, the width of the wide heat dissipation channel 528b may be greater than the widths of the basic heat dissipation channels 528a.

The reason why the heat dissipation sink 520 has the wide heat dissipation channel 528b as described above is to allow the heat dissipation sink 520 to be formed through an extrusion process, and to efficiently perform a work of creating a space for the washer member 510 to be installed in the heat dissipation sink 520. The heat dissipation sink 520 may be formed by being extruded along the direction D2 in which the plurality of heat dissipation fins 525 extends.

Air flowing by the heat dissipation fan 600 may pass through the heat dissipation channels 528 and exchange heat with the plurality of heat dissipation fins 525.

The temperature sensor 560 may include a sensor member 561 formed of a material having a changeable physical property, such as a resistance value, depending on a change in temperature of a target object. As an example, a thermistor, a negative temperature coefficient thermistor (NTC), a thermoelement, a thermocouple, etc., may be used as the sensor member 561.

The sensor member 561 may have a rectangular parallelepiped shape. That is, the sensor member 561 may include a lower surface 561a, an upper surface 561b parallel to the lower surface 561a, and side surfaces 561c, 561d, 561e, and 561f connecting the lower surface 561a and the upper surface 561b. The side surfaces 561c, 561d, 561e, and 561f may each have a rectangular shape. However, the shape of the sensor member 561 is not limited to a rectangular parallelepiped, and the sensor member 561 may have various shapes. As an example, the sensor member 561 may be formed in a cylindrical shape.

The sensor member 561 may be formed of a material that conducts heat well and is resistant to corrosion. In particular, the sensor member 561 may be formed of the same material as the heat dissipation sink 520 to prevent galvanic corrosion. As an example, the sensor member 561 and the heat dissipation sink 520 may be formed of the same aluminum material.

The sensor member 561 may be in contact with the heat dissipation sink 520 to measure the temperature of the heat dissipation sink 520. The sensor member 561 may be coupled to the heat dissipation sink 520.

The temperature sensor 560 may include a wire 563 connected to the sensor member 561. The wire 563 may be connected to the lower surface 561a of the sensor member 561.

The heat dissipation sink 520 may include a sensor receiving groove 526. The sensor receiving groove 526 may be formed to be recessed on the one surface 522a of the heat dissipation sink base 521. The sensor member 561 may be at least partially received in the sensor receiving groove 526. The drawings illustrate that a portion of the sensor member 561 is received in the sensor receiving groove 526, but depending on an embodiment, the entire sensor member 561 may be received in the sensor receiving groove 526.

The sensor receiving groove 526 may be formed along the direction D2 in which the heat dissipation fins 525 extend. That is, the direction D2 in which the sensor receiving groove 526 is formed may be the same as the direction D2 in which the heat dissipation sink 520 is extruded. Therefore, there is no need for separate processing such as cutting to form the sensor receiving groove 526, and the sensor receiving groove 526 may be integrally formed with the heat dissipation sink 520 through a single extrusion molding process.

The sensor receiving groove 526 may be formed between an edge 521a of the one surface 522a of the heat dissipation sink base 521 and an outermost heat dissipation fin 525a that is closest to the edge 521a of the one surface 522a of the heat dissipation sink base 521 among the plurality of heat dissipation fins 525. That is, the sensor receiving groove 526 may be formed outside the outermost heat dissipation fin 525a.

The edge 521a of the one surface 522a of the heat dissipation sink base 521 may be an edge along the arrangement direction D3 of the heat dissipation fins 525 of the one surface 522a of the heat dissipation sink base 521.

As such, because the sensor receiving groove 526 is formed outside the outermost heat dissipation fin 525a, the flow of air toward the sensor member 561 may be minimized. Therefore, the accuracy of temperature measurement of the heat dissipation sink 520 through the sensor member 561 may be improved.

The sensor receiving groove 526 may have a shape corresponding to the sensor member 561. As an example, an inner surface 527 of the sensor receiving groove 526 may include a first inner surface 527a, a second inner surface 527b vertically bent from one side of the first inner surface 527a, and a third inner surface 527c vertically bent from the other side of the first inner surface 527a and parallel to the second inner surface 527b.

The sensor member 561 may be received in the sensor receiving groove 526 so that at least three surfaces of the side surfaces 561c, 561d, 561e, and 561f are supported on the inner surface 527 of the sensor receiving groove 526.

Specifically, the first side surface 561c of the sensor member 561 may be supported on the first inner surface 527a of the sensor receiving groove 526. The second side surface 561d of the sensor member 561 may be supported on the second inner surface 527b of the sensor receiving groove 526. The third side surface 561e of the sensor member 561 may be supported on the third inner surface 527c of the sensor receiving groove 526.

In other words, the first side surface 561c of the sensor member 561 may be in contact with or be close to the first inner surface 527a of the sensor receiving groove 526. The second side surface 561d of the sensor member 561 may be in contact with or be close to the second inner surface 527b of the sensor receiving groove 526. The third side surface 561e of the sensor member 561 may be in contact with or be close to the third inner surface 527c of the sensor receiving groove 526.

Because by this structure, three surfaces of the sensor member 561 are supported on the inner surface 527 of the sensor receiving groove 526, not only may the sensor member 561 be stably fixed to the sensor receiving groove 526, but also an area with which the sensor member 561 and the heat dissipation sink 520 are in contact may be increased, so that the accuracy of temperature measurement of the heat dissipation sink 520 through the sensor member 561 may be improved.

The second inner surface 527b of the inner surface 527 of the sensor receiving groove 526 may be formed on the same plane as one surface 525b of the outermost heat dissipation fin 525a. Accordingly, a portion of the second side surface 561d of the sensor member 561 may be supported on the second inner surface 527b of the sensor receiving groove 526, and the remaining portion of the second side surface 561d of the sensor member 561 may be supported on the one side 525b of the outermost heat dissipation fin 525a. That is, the second side surface 561 of the sensor member 561 may be supported entirely on the heat dissipation sink 520. Therefore, the sensor member 561 may be more stably fixed to the sensor receiving groove 526, and the area with which the sensor member 561 and the heat dissipation sink 520 are in contact may be increased, thereby improving the accuracy of temperature measurement.

The sensor member 561 may be fixed to the sensor receiving groove 526 through the sensor fastening member 564. The sensor fastening member 564 may be a mechanical element for coupling, such as a screw or bolt. The sensor fastening member 564 may include a head SH and a fastening member body SB having a diameter smaller than the head SH. The fastening member body SB may have a cylindrical shape. Screw threads may be formed on an outer circumferential surface of the fastening member body SB.

The sensor fastening member 564 may be fastened to the heat dissipation sink base 521 of the heat dissipation sink 520 by penetrating the sensor member 561. A sensor passing hole 562 through which the sensor fastening member 564 passes may be formed on the sensor member 561. A sensor coupling hole 529 to which the sensor fastening member 564 is coupled may be formed on the heat dissipation sink base 521.

As described above, because the sensor member 561 is supported by the second inner surface 527b and the third inner surface 527c of the sensor receiving groove 526, the sensor member 561 may be prevented from rotating together while the sensor fastening member 564 rotates to couple the sensor member 561 and the heat dissipation sink 520. That is, there is no need to hold the sensor member 561 with a hand while fastening the sensor fastening member 564, and the sensor fastening member 564 may be fastened conveniently.

The rubber ring 564a may be provided between the head SH of the sensor fastening member 564 and the one surface 561f of the sensor member 561. The sensor fastening member 564 may pass through the rubber ring 564a. The rubber ring 564a may reduce vibration transferred to the sensor member 561 and the heat dissipation sink 520 by an operation of the heat dissipation fan 600, etc., thereby protecting the sensor member 561 and the heat dissipation sink 520 from impact and maintaining close contact between the sensor member 561 and the heat dissipation sink 520. However, the rubber ring 564a may be omitted, and the head SH of the sensor fastening member 564 may be in direct contact with the one surface 561f of the sensor member 561.

Referring to FIG. 15, similar to the heat dissipation sink 520, the cooling sink 570 may also be provided with the temperature sensor 565 for measuring the temperature of the cooling sink 570.

Hereinafter, the cooling sink 570 and the temperature sensor 565 will be described. Because structures of the cooling sink 570 and the temperature sensor 565 almost correspond to the structures of the heat dissipation sink 520 and the temperature sensor 561, even if not described below, the structures of the heat dissipation sink 520 and the temperature sensor 561 may be just applied to the structures of the cooling sink 570 and the temperature sensor 565.

The cooling sink base 571 may include one surface 572a and an opposite surface 572b opposite to the one surface 572a. The one surface 572a may face downward of the cooling sink base 571, and the other surface 572b may face upward of the cooling sink base 571.

The plurality of cooling fins 575 may protrude from the one surface 572a of the cooling sink base 571. The cooling conductive part 574 may protrude from the other surface 572b of the cooling sink base 571.

The plurality of cooling fins 575 may protrude from the one surface 572a of the cooling sink base 571. The plurality of cooling fins 575 may protrude in a direction D4 perpendicular to the one surface 572a of the cooling sink base 571. The plurality of cooling fins 575 may be formed to extend in a direction D5 parallel to the one surface 572a of the cooling sink base 571. The plurality of cooling fins 575 may be arranged in one direction D6 to be spaced apart from each other. The direction D6 in which the plurality of cooling fins 575 is arranged may be orthogonal to the direction D4 in which the plurality of cooling fins 575 protrudes and the direction D5 in which the plurality of cooling fins 575 extends.

Cooling channels 578 may be formed between the adjacent plurality of cooling fins 575. The cooling channels 578 may include basic cooling channels 578a and at least one wide cooling channel 578b having a width greater than widths of the basic cooling channels 578a. That is, the width of the wide cooling channel 578b may be greater than the widths of the basic cooling channels 578a.

The reason why the cooling sink 570 has the wide cooling channel 578b as described above is to allow the cooling sink 570 to be formed through the extrusion process, and to efficiently perform a work of creating a space for the nut member 590 to be installed in the cooling sink 570. The cooling sink 570 may be formed by being extruded along the direction D5 in which the plurality of cooling fins 575 extends.

Air flowing by the cooling fan 800 may pass through the cooling channels 578 and exchange heat with the plurality of cooling fins 575.

The temperature sensor 565 may include a sensor member 566 formed of a material having a changeable physical property, such as a resistance value, depending on a change in temperature of a target object. As an example, a thermistor, a negative temperature coefficient thermistor (NTC), a thermoelement, a thermocouple, etc., may be used as the sensor member 566.

The sensor member 566 may have a rectangular parallelepiped shape. However, the shape of the sensor member 566 is not limited to a rectangular parallelepiped, and the sensor member 566 may have various shapes. As an example, the sensor member 566 may be formed in a cylindrical shape.

The sensor member 566 may be formed of a material that conducts heat well and is resistant to corrosion. In particular, the sensor member 566 may be formed of the same material as the cooling sink 570 to prevent galvanic corrosion. As an example, the sensor member 566 and the cooling sink 570 may be formed of the same aluminum material.

The temperature sensor 565 may include a wire 568 connected to the sensor member 566.

The cooling sink 570 may include a sensor receiving groove 576. The sensor receiving groove 576 may be formed to be recessed on the one surface 572a of the cooling sink base 571. The sensor member 566 may be at least partially received in the sensor receiving groove 576. The drawings illustrate that a portion of the sensor member 566 is received in the sensor receiving groove 576, but depending on an embodiment, the entire sensor member 566 may be received in the sensor receiving groove 576.

The sensor receiving groove 576 may be formed along the direction D5 in which the cooling fins 575 extend. That is, the direction D5 in which the sensor receiving groove 526 is formed may be the same as the direction D2 in which the cooling sink 570 is extruded. Therefore, there is no need for separate processing such as cutting to form the sensor receiving groove 576, and the sensor receiving groove 576 may be integrally formed with the cooling sink 570 through the single extrusion molding process.

The sensor receiving groove 576 may be formed between an edge 571a of the one surface 572a of the cooling sink base 571 and an outermost cooling fin 575a that is closest to the edge 571a of the one surface 572a of the cooling sink base 571 among the plurality of cooling fins 575. That is, the sensor receiving groove 576 may be formed outside the outermost cooling fin 575a.

The edge 571a of the one surface 572a of the cooling sink base 571 may be an edge along the arrangement direction D6 of the cooling fins 575 of the one surface 572a of the cooling sink base 571.

As such, because the sensor receiving groove 576 is formed outside the outermost cooling fin 575a, the flow of air toward the sensor member 566 may be minimized. Therefore, the accuracy of temperature measurement of the cooling sink 570 through the sensor member 566 may be improved.

The sensor receiving groove 576 may have a shape corresponding to the sensor member 566. The sensor member 566 may be received in the sensor receiving groove 576 so that at least three surfaces of the side surfaces are supported on the inner surface of the sensor receiving groove 576.

By this structure, not only may the sensor member 566 be stably fixed to the sensor receiving groove 576, but also an area with which the sensor member 566 and the cooling sink 570 are in contact may be increased, so that the accuracy of temperature measurement of the cooling sink 570 through the sensor member 566 may be improved.

The sensor member 566 may be fixed to the sensor receiving groove 576 through the sensor fastening member 569. The sensor fastening member 569 may be a mechanical element for coupling, such as a screw or bolt.

The sensor fastening member 569 may be fastened to the cooling sink base 571 of the cooling sink 570 by penetrating the sensor member 566. A sensor passing hole 567 through which the sensor fastening member 569 passes may be formed on the sensor member 566. A sensor coupling hole 579 to which the sensor fastening member 569 is coupled may be formed on the cooling sink base 571.

The rubber ring 569a may be provided between a head of the sensor fastening member 569 and the one surface of the sensor member 566. The sensor fastening member 569 may pass through the rubber ring 569a. The rubber ring 569a may reduce vibration transferred to the sensor member 566 and the cooling sink 570 by the operation of the heat dissipation fan 600, etc., thereby protecting the sensor member 566 and the cooling sink 570 from impact and maintaining close contact between the sensor member 566 and the cooling sink 570. However, the rubber ring 569a may be omitted, and the head of the sensor fastening member 569 may be in direct contact with one surface of the sensor member 566.

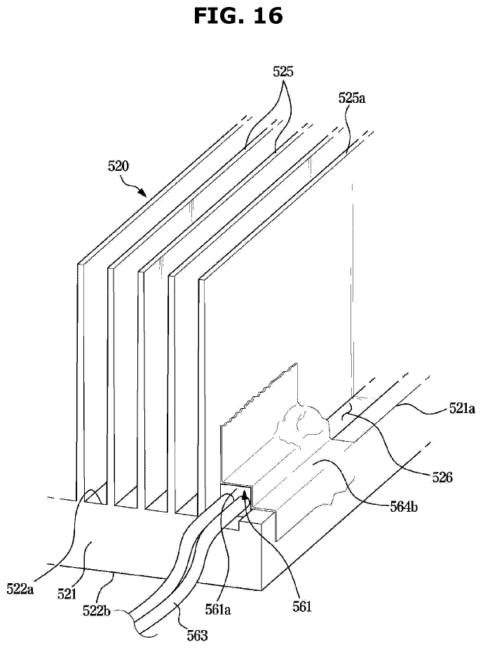

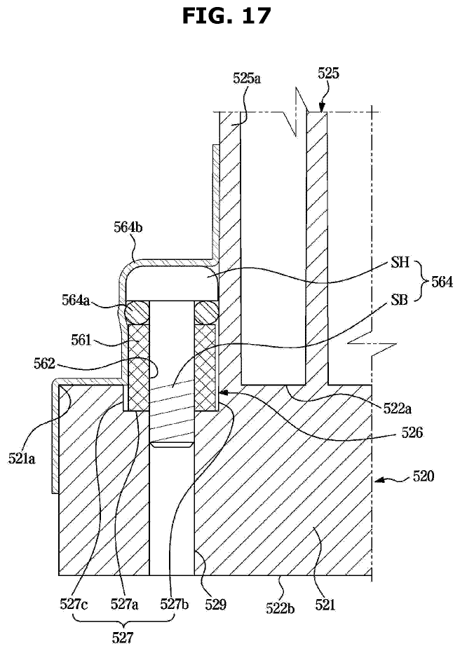

FIG. 16 is a perspective view illustrating a structure in which the temperature sensor is coupled to the heat dissipation sink through a thermal conductive tape according to an embodiment of the present disclosure. FIG. 17 is a cross-sectional view illustrating a structure in which the temperature sensor in FIG. 16 is coupled to the heat dissipation sink through the thermal conductive tape.

Referring to FIGS. 16 and 17, the thermoelectric module 500 may further include a thermal conductive tape 564b provided to fix the sensor member 561 to the sensor receiving groove 526.

A portion of the thermal conductive tape 564b may be adhered to at least one surface of the sensor member 561, and at least another portion of the thermal conductive tape 564b may be adhered to at least one surface of the heat dissipation sink 520.

The sensor member 561 may be more stably fixed to the sensor receiving groove 526 by the thermal conductive tape 564b. In a case where the thermal conductive tape 564b is attached, the rubber ring 564a may be omitted.

The thermal conductive tape 564b may include a material with high thermal conductivity. As an example, the thermal conductive tape 564b may include an aluminum tape. Therefore, the thermal conductive tape 564b may improve a thermal conductivity from the heat dissipation sink 520 to the sensor member 561, and the accuracy of temperature measurement of the heat dissipation sink 520 through the sensor member 561 may be improved.

By means of the thermal conductive tape 564b, the sensor member 561 may sense a temperature through all of the four side surfaces 561c, 561d, 561e, and 561f.

Such the thermal conductive tape 564b may be equally applied to the cooling sink 570 and the temperature sensor 565, and therefore, a description thereof will be omitted.

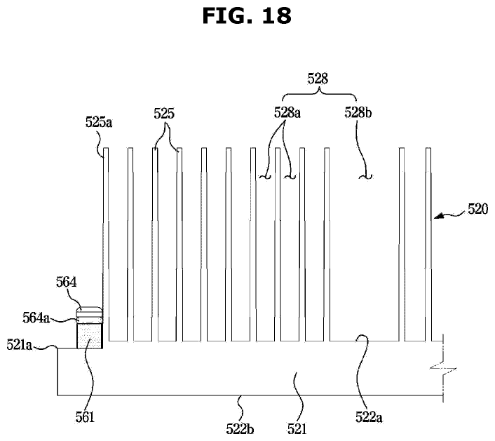

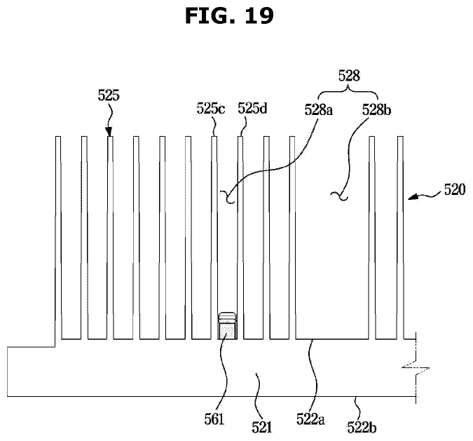

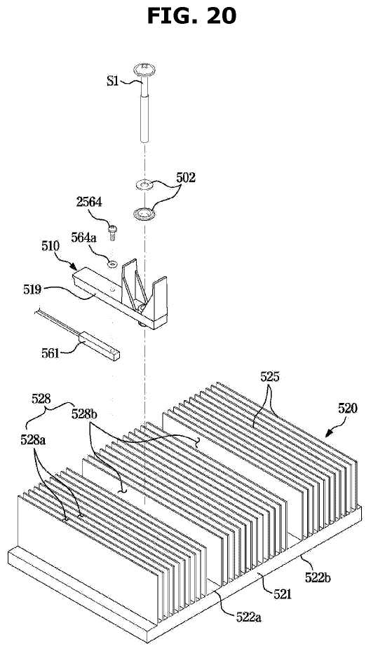

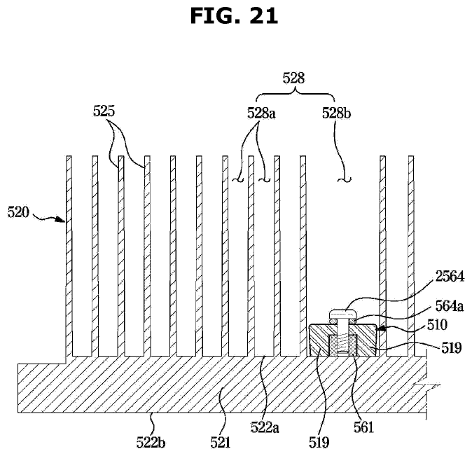

FIG. 18 is a front view illustrating the combined structure of the temperature sensor and the heat dissipation sink according to an embodiment of the present disclosure. FIG. 19 is a front view illustrating the combined structure of the temperature sensor and the heat dissipation sink according to an embodiment of the present disclosure. FIG. 20 is an exploded perspective view illustrating the temperature sensor, the heat dissipation sink, and a washer member according to an embodiment of the present disclosure. FIG. 21 is a cross-sectional view illustrating a combined structure of the temperature sensor, the heat dissipation sink, and the washer member in FIG. 20.

The configuration described below with reference to FIGS. 18 to 21 may be equally applied to a configuration of the cooling sink 570 and the temperature sensor 565, and therefore, a description thereof will be omitted.

Referring to FIG. 18, according to an embodiment, the sensor receiving groove 526 may not be formed on the heat dissipation sink base 521. In this case, the sensor member 561 may be provided to be supported on the one surface 522a of the heat dissipation sink base 521 and the outermost heat dissipation fin 525a. That is, two side surfaces of the sensor member 561 may be supported on the heat dissipation sink 520.

Referring to FIG. 19, according to an embodiment, the sensor member 561 may be disposed in the basic heat dissipation channel 528a. That is, the sensor member 561 may be disposed between a plurality of adjacent heat dissipation fins 525c and 525d forming the basic heat dissipation channel 528a.

One side surface of the sensor member 561 may be supported on the one surface 522a of the heat dissipation sink base 521, another side surface of the sensor member 561 may be supported on the heat dissipation fin 525c, and another side surface of the sensor member 561 may be supported on the heat dissipation fin 525d. Three side surfaces of the sensor member 561 may be supported on the heat dissipation sink 520.

Referring to FIG. 20, according to an embodiment, the sensor element 561 may be disposed in the wide heat dissipation channel 528b. In this case, the sensor member 561 may be provided between a bottom surface of the washer member 510 and the one surface 522a of the heat dissipation sink base 521.

The sensor member 561 may be coupled to the washer member 510. The sensor member 561 may be coupled to the washer member 510 by a sensor fastening member 2564. The sensor fastening member 2564 may be coupled to the sensor member 561 by penetrating the washer member 510.

A sensor mounting portion 519 provided to allow the sensor member 561 to be mounted may be formed on the washer member 510. The sensor mounting portion 519 may be formed on the bottom surface of the washer member 510.

Although the technical idea of the present disclosure has been described above by specific embodiments, the scope of the present disclosure is not limited to these embodiments. Various embodiments that may be modified or changed by a person of ordinary skill in the art within the scope that does not deviate from the technical idea of the present disclosure as stated in the claims may also fall within the scope of the present disclosure.

What is claimed is:

1. A refrigerator comprising:
a main body;
a storage compartment formed inside the main body;
a thermoelectric element configured to cool the storage compartment;
a heat sink in contact with the thermoelectric element, the heat sink comprising:
a sink base; and
a plurality of fins protruding from one surface of the sink base;
a temperature sensor configured to measure a temperature of the heat sink, the temperature sensor comprising:
a sensor member; and
a wire connected to the sensor member; and
a sensor fastening member coupled to the heat sink by penetrating the sensor member to fix the sensor member,
wherein the heat sink comprises a sensor receiving groove recessed in the one surface of the sink base, and
wherein the sensor member is received in the sensor receiving groove.

2. The refrigerator according to claim 1, wherein:
the plurality of fins comprises an outermost fin disposed closest to an edge of the one surface of the sink base among the plurality of fins; and
the sensor receiving groove is formed between the edge of the one surface of the sink base and the outermost fin.

3. The refrigerator according to claim 1, wherein:
the plurality of fins protrudes in a first direction perpendicular to the one surface of the sink base;
the plurality of fins each extends in a second direction perpendicular to the first direction; and
the plurality of fins is spaced apart from each other along a third direction perpendicular to the first direction and the second direction.

4. The refrigerator according to claim 3, wherein
the sensor receiving groove is formed along the second direction.

5. The refrigerator according to claim 1, wherein
the sensor member has a rectangular parallelepiped shape.

6. The refrigerator according to claim 5, wherein
at least three surfaces of the sensor member are supported by an inner surface of the sensor receiving groove.

7. The refrigerator according to claim 6, wherein
the inner surface of the sensor receiving groove comprises:
a bottom surface;
a first surface extending from the bottom surface; and
a second surface extending from the bottom surface and parallel to the first surface.

8. The refrigerator according to claim 7, wherein
the first surface is formed on a same plane as a surface of any one of the plurality of fins.

9. The refrigerator according to claim 1, wherein
the sensor member is formed of a same material as the heat sink.

10. The refrigerator according to claim 1, wherein
the sensor member is disposed adjacent to an outermost fin among the plurality of fins.

11. The refrigerator according to claim 1, wherein
the sensor member comprises a sensor passing hole through which the sensor fastening member passes.

12. The refrigerator according to claim 1, wherein
the heat sink comprises a sensor coupling hole to which the sensor fastening member is coupled.

13. The refrigerator according to claim 1, wherein
the sensor fastening member comprises:
a head; and
a fastening member body having a size smaller than a size of the head, and
wherein the refrigerator further comprises a rubber ring disposed between the head and the sensor member.

14. The refrigerator according to claim 1, further comprising:
a thermal conductive tape, the thermal conductive tape having:
a first portion adhered to at least one surface of the sensor member; and
a second portion adhered to at least one surface of the heat sink, to fix the sensor member in the sensor receiving groove.

15. The refrigerator according to claim 3, wherein
the heat sink is extruded along the second direction.

16. A refrigerator comprising:
a main body;
a storage compartment formed inside the main body;
a thermoelectric element configured to cool the storage compartment;
a heat sink in contact with the thermoelectric element, the heat sink including:
a sink base; and
a plurality of fins protruding from one surface of the sink base; and
a temperature sensor configured to measure a temperature of the heat sink, the temperature sensor including:
a sensor member; and
a wire connected to the sensor member,
wherein a plurality of channels is disposed between the plurality of fins, and
wherein the sensor member is disposed in the one surface of the sink base and disposed in any one of the plurality of channels.

17. The refrigerator according to claim 16, wherein the plurality of channels includes:
a plurality of basic channels; and
at least one wide channel having a width greater than a width of each of the plurality of basic channels.

18. The refrigerator according to claim 17, wherein each of the plurality of basic channels includes a first fin and a second fin, and
wherein the sensor member is disposed in one of the plurality of the basic channels and supported between the first fin and the second fin.

19. The refrigerator according to claim 17, wherein the sensor member is disposed in the at least one wide channel.

20. The refrigerator according to claim 16, further comprising:
a module plate to support the heat sink;
a module fastening member to couple the heat sink and the module plate; and
a washer member disposed between a head of the module fastening member and the heat sink,
wherein the washer member is disposed in the wide channel, and the fastening member is coupled to the washer member.
